(19) United States
(12) Patent Application Publication
(10) Pub. No.: US 2007/0202843 A1
(43) Pub. Date: Aug. 30, 2007

(54) Method and system for data partitioning and encoding for transmission of uncompressed video over wireless communication channels

(75) Inventors: Huaning Niu, Sunnyvale, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Elctronics Co., Ltd., Suwon City (KR)

(21) Appl. No.: 11/655,815

(22) Filed: Jan. 18, 2007

Related U.S. Application Data
(60) Provisional application No. 60/773,826, filed on Feb. 15, 2006.

(51) Int. Cl. H04Q 7/20

(52) U.S. Cl. 455/403

(57) ABSTRACT

A method of transmitting uncompressed video over a wireless channel by inputting a frame of pixel information, partitioning spatially correlated (neighboring) pixels into different packets, generating error detection data for each packet and appending the error detection data to each packet, encoding the pixel data, and transmitting the packets separately over a wireless channel. A receiver receives the transmitted packets, decodes the packets, and checks if a received packet is corrupt based on the appended error detection data. For a corrupt packet, the receiver corrects the corrupt pixels using pixel information in other received packets containing neighboring pixels to recover each corrupt pixel in the corrupt packet.

### RELATED APPLICATION

This application claims priority from U.S. Provisional Patent Application Ser. No. 60/773,826, filed on Feb. 15, 2006, incorporated herein by reference.

### FIELD OF THE INVENTION

The present invention relates to wireless communications and in particular, to transmission of uncompressed video over wireless communication channels.

### BACKGROUND OF THE INVENTION

With the proliferation of high quality video, an increasing number of electronic devices (e.g., consumer electronic devices) utilize high-definition (HD) video. Conventionally, most devices compress the HD video, which can be around 1 Gbps (Giga bits per second) in bandwidth, to a fraction of its size to allow for transmission between devices. However, with each compression and subsequent decompression of the video, some video information can be lost and the picture quality is degraded.

The High-Definition Multimedia Interface (HDMI) specification allows the transfer of uncompressed HD video signals between devices via a cable. While consumer electronics makers are beginning to offer HDMI-compatible equipment, there is not yet a suitable wireless (e.g., radio frequency) technology that is capable of transmitting uncompressed HD video signals. Existing wireless Local Area Networks (WLANs) and similar technologies do not have the bandwidth needed to carry uncompressed HD video, such as providing an air interface to transmit uncompressed video over a 60 GHz bandwidth. Further, existing WLANs can suffer from interference issues when several devices are connected, leading to video signal degradation.

### BRIEF SUMMARY OF THE INVENTION

The present invention provides a method and system for data partitioning and encoding for transmission of uncompressed video over wireless communication channels.

In one embodiment, the present invention provides a method and system for spatial video pixel partitioning and encoding that allows transmission of uncompressed HD video from a transmitter to a receiver over a wireless channel, and further allows error recovery at the receiver.

An implementation of said embodiment of the present invention involves inputting a frame of pixel information, and partitioning spatially correlated pixels. Then, the partitioned pixels are placed into different packets and error detection information is generated for each packet and appended thereto. The packets are then transmitted by a transmitter to a receiver over a wireless channel. Based on the appended error detection data in each packet, the receiver determines if a received packet is corrupt. If a packet is corrupt, then the receiver recovers the corrupt pixels using pixel information in other received packets containing neighboring pixels. As a result, retransmission of corrupt pixels is not required. This improves transmission robustness and reduces channel bandwidth requirements.

Preferably, the partitioned pixels are placed into packets such that pixels with minimal spatial distance (i.e., neighboring pixels) are placed into different packets for transmission over the wireless channel. This can further include partitioning spatially correlated pixels into K different partitions, and selecting the value of the n^{th} pixel at each K pixel block as base information. Then, the base information is placed in a packet as BASE pixels, and information of other pixels in the pixel block is encoded within the same block and placed in another packet as DIFF pixels.

In accordance with further features of the preferred embodiment of the present invention, recovering the corrupt pixels further includes determining a difference between each corrupt pixel in a corrupt packet with a corresponding pixel of an adjacent non-corrupt packet, and if the difference is greater than a threshold, then correcting each corrupt pixel using pixel information in that adjacent non-corrupt packet. Such correcting steps can be performed by replacing each corrupt pixel with a corresponding pixel in the adjacent non-corrupt packet, or by using an average of neighboring pixels of a corresponding pixel in the non-corrupt packet.

These and other features, aspects and advantages of the present invention will become understood with reference to the following description, appended claims and accompanying figures.

### BRIEF DESCRIPTION OF THE DRAWINGS

FIG. 1 shows a flowchart of an embodiment of a process for spatial partitioning of uncompressed video pixels for transmission over a wireless channel, according to an embodiment of the present invention.

FIG. 2 shows an example of spatial partitioning of pixels into two partition packets, according to an embodiment of the present invention.

FIG. 3 shows another example of spatial partitioning of pixels into four partition packets, according to an embodiment of the present invention.

FIG. 4 shows a flowchart of an embodiment of a process for processing packets received at a receiver, according to an embodiment of the present invention.

FIG. 5 shows a functional block diagram of an example communication system implementing spatial pixel partitioning and encoding mechanisms for transmission of uncompressed HD video over a wireless channel, according to an embodiment of the present invention.

FIG. 6 shows an example of differential pulse code modulation (DPCM) or binary XOR (bXOR) encoding for DIFF pixels, according to an embodiment of the present invention.

FIG. 7 shows an example of DPCM (or bXOR) and run-length coding (RLC) for DIFF pixels, according to an embodiment of the present invention.

In the drawings, like references refer to similar elements.

### DETAILED DESCRIPTION OF THE INVENTION

The present invention provides a method and system for data partitioning and encoding for transmission of uncompressed video over wireless communication channels.

In one embodiment, the present invention provides a method and system for spatial video pixel partitioning and encoding that allow transmission of uncompressed HD video from a transmitter to a receiver over a wireless channel.

In a preferred embodiment, the present invention further provides an error recovery and encoding method based on said pixel partitioning method. This can improve the uncompressed video transmission robustness and can also reduce transmission bandwidth requirements.

According to said embodiment of the present invention, neighboring pixels in a video frame are partitioned into different packets and transmitted separately over wireless channels from a transmitter to a receiver. If one packet is received corrupted (i.e., pixels are lost or received with errors), then packets carrying the neighboring pixels are used to recover the pixels in the corrupt packet. As such, retransmission of lost information is not required, which saves transmission bandwidth.

The present invention provides further error recovery and encoding steps based on data partitioning for transmission of uncompressed video signals, especially for large packet lengths, as is the case in transmission of uncompressed video such as uncompressed HD video.

Wireless transmission of uncompressed HD video (WiHD) requires greater than 80% Medium Access Control (MAC) packet transmission efficiency. Due to such high MAC efficiency requirements (and a relatively static channel), a WiHD packet can be very long (i.e., typically 300K-600K bits long). On the other hand, using transmit beamforming at a WiHD transmitter, the bit error rate (BER) of such a packet is low (less than 10⁻⁶). As such, when an erroneous packet is received at a WiHD receiver, the packet typically includes less then 10 erroneous bits. Rather than discarding the entire packet, the erroneous pixels/bits are corrected based on adjacent packets, according to the preferred embodiment of the present invention.

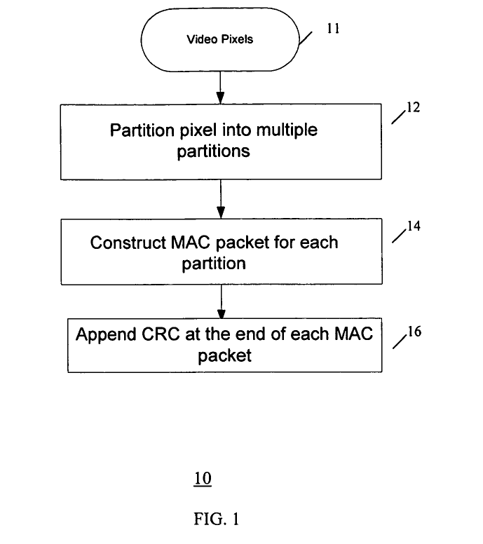

FIG. 1 shows a flowchart 10 of an embodiment of a process for partitioning video pixels at a wireless transmitter, according to a preferred embodiment of the present invention, including the steps of:
Step 11: Inputting video pixels.
Step 12: determining a number of partitions K, and then partitioning pixels into K different partitions.
Step 14: Constructing a MAC packet for each partition (i.e., packetizing), and placing the corresponding partition pixels into the MAC packet.
Step 16: Determining error detection data (e.g., such as Cyclic Redundancy Code (CRC)) for each MAC packet, and appending the error detection data to the MAC packet. The MAC packet is an example of the WiHD packet described above, for transmission from a transmitter to a receiver over wireless channels.

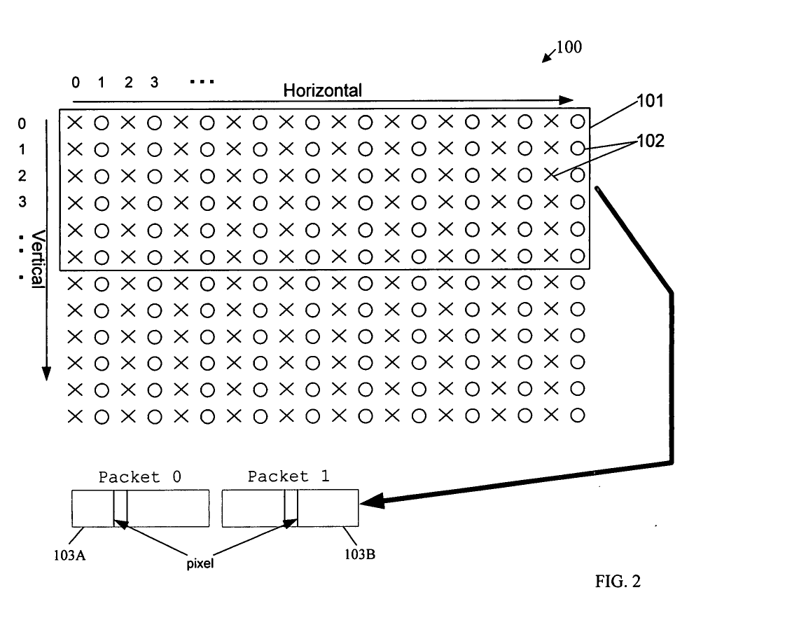

FIG. 2 shows a diagrammatical example application of the above partitioning and packetizing steps for K=2 partitions. An uncompressed video frame 100 includes a set 101 of pixels 102. The spatial location of each pixel 102 in the frame 100 can be identified by a column index i (horizontal), and a row index j (vertical). Each of the indices i and j can take on integer values 0, 1, 2, 3, 4, etc.

The pixels 102 are split horizontally into two groups: (1) the first group of pixels (marked as “X”) have index i=0, 2, 4, . . . , etc., per line and index j=0, 1, 2, . . . , etc.; and (2) the second group of pixels (marked as “O”) have indices i=1, 3, 5, . . . , etc., per line and indices j=0, 1, 2, . . . , etc. Then, as shown in FIG. 2, pixels from the first group are placed in a first packet 103A (i.e., Packet 0), and pixels from the second group are placed in a second packet 103B (i.e., Packet 1). Therefore, one or more pixels of first group are placed in the Packet 0, and one or more pixels of second group are placed in the Packet 1. As a result, spatially neighboring pixels are partitioned and placed into different packets.

Packet size is selected depending on transmitter and receiver buffer requirements. One or more lines worth of pixels can be placed in each packet. A CRC for each packet is computed and appended at the end of the packet before transmission to a receiver over a wireless channel.

In the uncompressed video frame 100, geographically neighboring (spatially correlated) pixels usually have very similar, or even the same values. Regardless of how pixel partitioning is performed, so long as spatially neighboring pixels are partitioned and placed into different packets for transmission, then if pixel information in a received packet is corrupted (i.e., lost or damaged), one or more other packets which contain pixels that are spatially related to the corrupt pixel(s) can be used to recover (compensate for) the corrupt pixel information.

Preferably, partitioning is performed such that pixels with minimal spatial distance are placed into different packets for transmission over a wireless channel. Further, partitioning can be performed by distributing y number of spatially correlated pixels into z number of different packets, wherein y≠z. In one example, y can be greater than z, whereby at least one of the packets includes two or more spatially correlated (neighboring) pixels from a partition. It is also possible to split pixels vertically. However, for interlaced format, since two neighboring lines are already split into two separate fields, it is preferable to partition horizontally for each field if only two partitions are required.

If more than two partitions are needed, then a combination of horizontal and vertical partitioning can be considered, as well as horizontal splitting or vertical splitting. Additional examples of partitioning according to the present invention wherein pixels are partitioned into more than two groups are provided below.

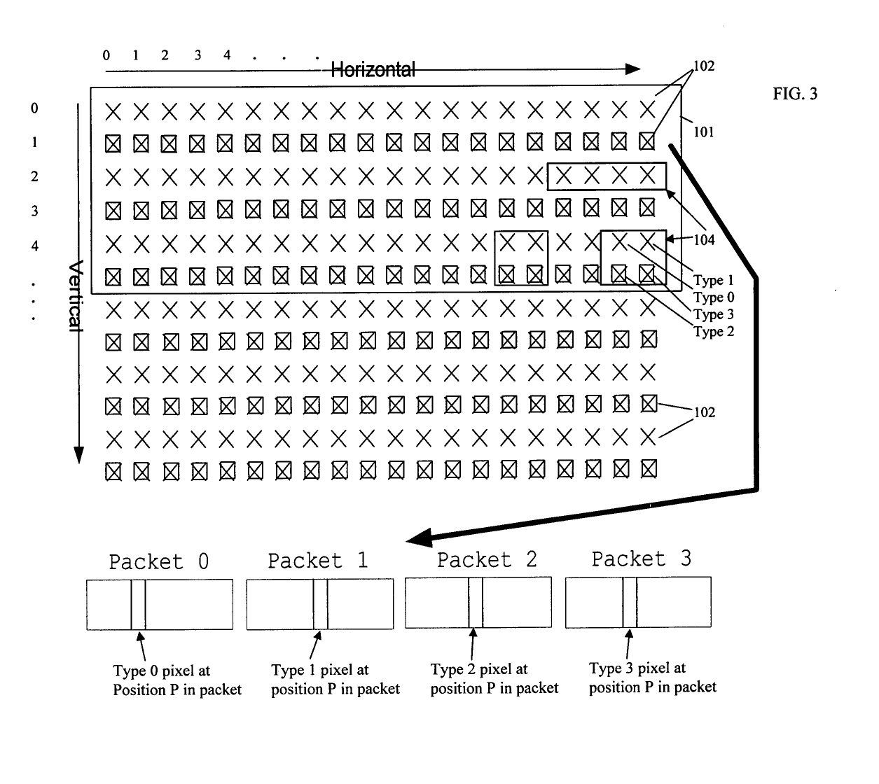

FIG. 3 shows an example application of the partitioning and packetizing steps for K=4 partitions. In this example, the pixels are split into, four types (i.e., Types 0, 1, 2, 3) of 2×2 blocks 104, wherein K=4 pixels per block. The four pixels in each 2×2 block 104 are placed into 4 different packets (i.e., Packets 0, 1, 2, 3). Pixels with minimal spatial distance are placed into different packets for transmission.

Specifically, for the Type 0 pixels, the indices i and j are even numbers (i.e., i=0, 2, 4, . . . , etc., and j=0, 2, 4, . . . , etc.), and the Type 0 pixels are placed in the Packet 0. For the Type 1 pixels, the index i is odd (i.e., i=1, 3, 5, . . . , etc.), the index j is even (i.e., j=0, 2, 4, . . . , etc.), and the Type 1 pixels are placed in the Packet 1. For the Type 2 pixels, the index i is even (i.e., i=0, 2, 4, . . . , etc.), the index j is odd (i.e., j=1, 3, 5, . . . , etc.), and the Type 2 pixels are placed in the Packet 2. For the Type 3 pixels, the indices i and j are odd numbers (i.e., i=1, 3, 5, . . . , etc., and j=1, 3, 5, . . . , etc.), and the Type 3 pixels are placed in the Packet 3. A CRC for each packet is appended at the end of the packet before transmission to a receiver of a wireless channel.

At the receiver, the received packets are processed for errors. When based on a CRC check a packet is determined to be corrupt, in order to determine the corrupted pixels, all the pixels in the corrupt packet are compared with corresponding pixels in an adjacent non-corrupt packet, on a pixel-by-pixel basis. If there is a sharp change (i.e., greater than a pre-defined threshold) between two corresponding pixels which belong to different partitions/packets, then the pixel in the corrupt packet is likely wrong, and it is corrected by interpolation based on adjacent correct packets (described below). Otherwise, the pixel is used as is.

If during transmission, a pixel in one packet (e.g., Packet 0) is corrupted, then spatially related pixels in the other three packets (e.g., Packets 1, 2, or 3) can be used at the receiver to compensate for the corrupted pixel. As such, if pixel information in position P in a packet (e.g., Packet 0 in FIG. 3) is corrupted, then the pixel information in position P in other spatially related packets (e.g., Packets 1, 2, or 3) can be used to compensate for the corrupted information. Different packets can be transmitted at a single channel or at different channels/paths.

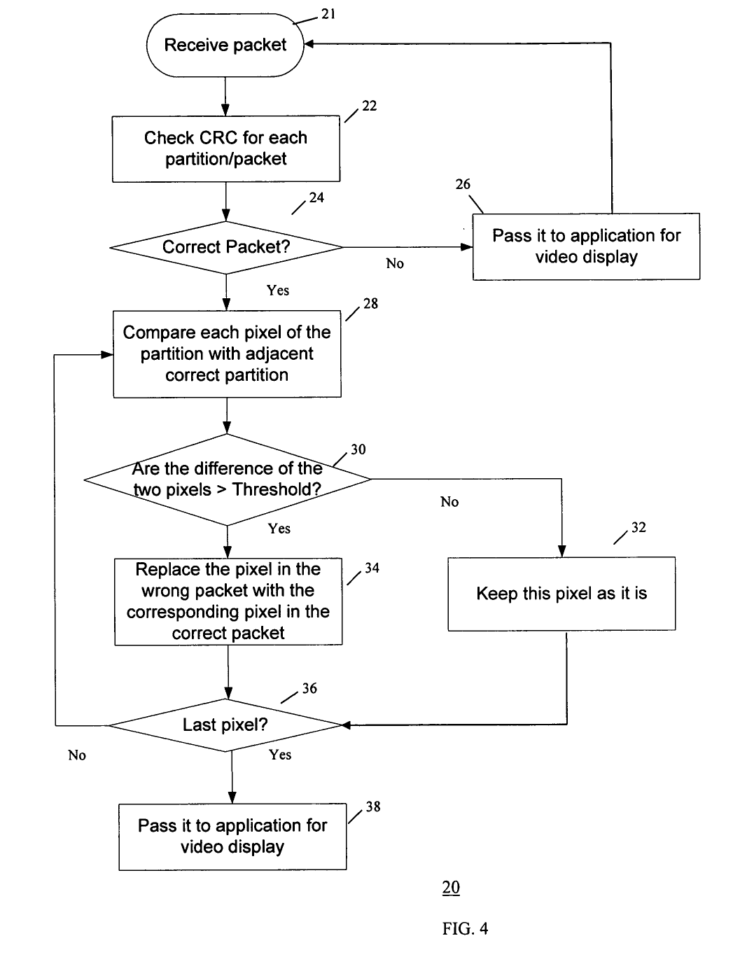

FIG. 4 shows a flowchart 20 of the steps for processing packets received at a receiver, in an embodiment of the invention, including the steps of:
Step 21: Receive a packet.
Step 22: Check the CRC for a received packet.
Step 24: Based on the CRC, determine if the packet is corrupt (i.e., lost or erroneous pixel values). If not, go to step 26, otherwise go to step 28.
Step 26: Pass the received packet to higher layers for display. Go to step 21 to process the next packet.
Step 28: Determine a difference between each pixel in the corrupt packet with a corresponding pixel of an adjacent non-corrupt packet.
Step 30: Determine if the difference is greater than a threshold. If not, go to step 32, otherwise go to step 34.
Step 32: Retain the pixel. Go to step 36.
Step 34: Correct the pixel. In one example (e.g., K=2 partitions), correcting the pixel includes replacing the pixel in the corrupt packet with a corresponding pixel of the adjacent non-corrupt packet. In another example (K=4 partitions), correcting a corrupt pixel includes replacing the pixel in the corrupt packet with the average value of the neighboring pixels of an adjacent non-corrupted packet.
Step 36: Determine if any other pixels remain in the corrupt packet for processing. If not, go to step 38, otherwise go back to step 28.
Step 38: Pass the packet to higher levels for display. Go back to step 21.

Each received packet is processed according to the above steps for error detection and recovery.

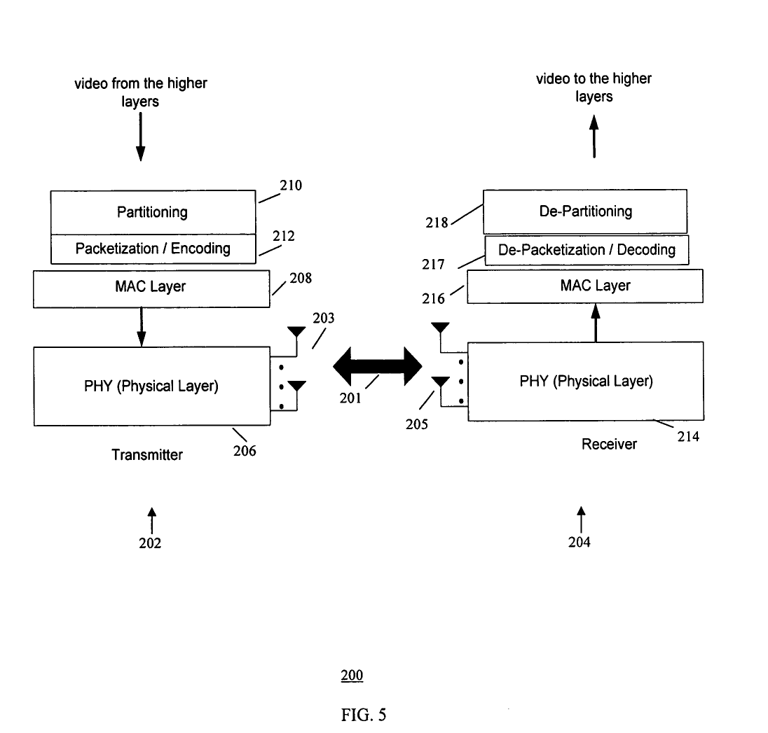

FIG. 5 shows a functional block diagram of an example wireless communication system 200, according to an embodiment of the present invention. The system 200 includes a WiHD transmitter 202 and a WiHD receiver 204. The transmitter 202 includes a PHY layer 206 and a MAC layer 208. Similarly, the receiver 204 includes a PHY layer 214 and a MAC layer 216. The PHY and MAC layers enable wireless communication between the WiHD transmitter 202 and the WiHD receiver 204 via transmit antennas 203 and receiver antennas 205, respectively, over a wireless channel 201.

The transmitter 202 further includes a partitioning module 210 that receives video frames and implements the above partitioning steps on uncompressed video from higher layers, and a packetization and encoding module 212 that generates packets of data. The MAC layer 208 converts each data packet into a MAC packet by adding a MAC header to each data packet, and further calculates and adds CRC information to the data packet. The MAC packets are then provided to the PHY layer 206. The PHY layer 206 adds a PHY header to each MAC packet for transmission to the WiHD receiver 204 via transmit antennas 203.

In the receiver 204, the PHY layer 214 receives transmitted packets. The MAC layer 216 processes each received packet and performs error detection and error recovery according to the steps in the flowchart of FIG. 4. The WiHD receiver 204 further includes a de-packetization and decoding module 217 and a de-partitioning module 218. The de-packetization and decoding module 217 receives the processed packets from the MAC layer 216 and provides the bits in the packets to the de-partitioning module 218. The de-partitioning module 218 performs an inverse partitioning method of the partitioning module 210 to regenerate a video frame from the partitioned pixels in the packets.

In implementation, the MAC layer 208, the partitioning module 210, and the packetization and encoding 212 in the WiHD transmitter 202 are logical modules. As such, though in the example of FIG. 5 the partitioning module 210 and the packetization and encoding module 212 are shown as separate from the MAC layer 208, in another example, one or both of the logical modules 210 and 212 can be a component of the MAC layer 208. Similarly, in the WiHD receiver 204, one or both of the de-partitioning module 218 and the de-packetization and decoding module 217 can be components of the MAC layer 216.

In some cases, it may be difficult for wireless hardware and PHY layers to meet the bandwidth requirements of uncompressed HD video transmission. In such cases, according to another aspect of the present invention, first the pixel partitioning process described above is used to partition the neighboring video pixels into K partitions, and then an encoding process in the module 212 compresses the video information in each packet before transmission to the WiHD receiver 204. At the WiHD receiver 204 the packets are decompressed by a decoding function of the module 217. Compression within each packet is more effective than performing compression across different packets. Each packet is equally compressed as other packets, while adjacent bits within each packet remain still highly correlated.

Performing compression within each packet avoids error propagation from a first packet to a second packet. Therefore, even if a first received packet is corrupt, the remaining packets can still be received uncorrupted.

In a preferred embodiment of performing encoding according to the present invention, after partitioning the pixels into K partitions, instead of placing all of the original video data information into K packets, the value of an n^{th} fixed position pixel (n<K) is selected at each K pixel block (i.e., for K partitions, every K pixels forms a block) as BASE pixels. Then, the information for other pixels in each block is encoded within the same block as DIFF pixels, such as by DPCM or bXOR encoding). As such, the encoded pixels are termed DIFF pixels, and the pixels carrying the original video data are termed BASE pixels.

Because spatially correlated (e.g., neighboring) pixels usually have very similar values or even the same values, after a DPCM or bXOR encoding operation, the Most Significant Bits (MSBs) of the DIFF pixels are mostly zero. In order to conserve transmission bandwidth, the zero bits need not be transmitted. Two example implementations of such an approach are hard truncation and Run Length Coding (RLC) as described below.

An example of hard truncation involves truncating the high order zero bits of encoded DIFF pixels, such that less number of bits is needed for transmission. Assuming one pixel has D bits, for a BASE pixel all of the D bits are used to carry the original data information. However, for a DIFF pixel, D1 bits (D1<D) are used for DPCM or bXOR encoding. Preferably, the exact value of D1 is selected in advance, according to video content types. If D1 is selected to be less than the bits required to carry encoded information for a DIFF pixel, then the D1 bits are set to the value closest to the real encoded value.

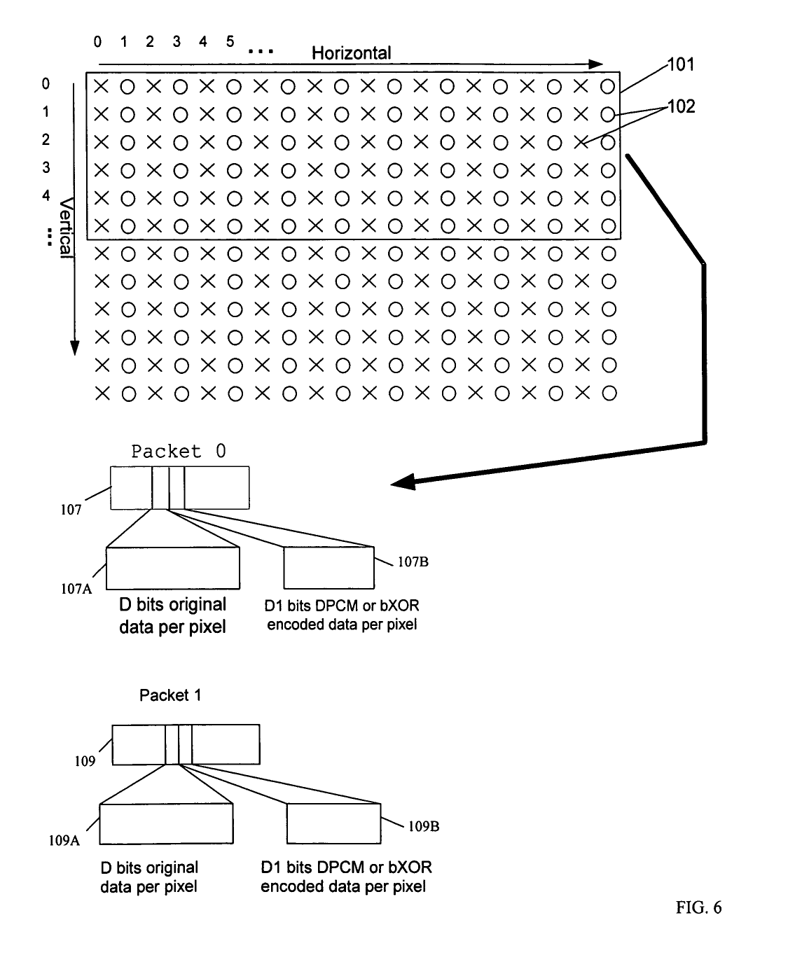

FIG. 6 shows an encoding scheme based on DPCM or bXOR encoding, wherein K=2 partitions. Similar to FIG. 2, in FIG. 6 the pixels are split horizontally into two groups: (1) the first group of pixels have indices i=0, 2, 4, . . . , etc., and indices j=0, 1, 2, . . . , etc.; and (2) the second group of pixels have indices i=1, 3, 5, . . . , etc., and indices j=0, 1, 2, . . . , etc.

A first packet 107 (i.e., Packet 0) is constructed which includes D bits 107A of the original data per pixel for said first group of pixels (BASE pixels). The first packet 107 further includes D1 bits 107B per pixel for said first group of pixels (DIFF pixels) that are DPCM or bXOR encoded. Similarly, a second packet 109 (i.e., Packet 1) is constructed which includes D bits 109A of the original data per pixel for said second group of pixels (BASE pixels). The second packet 109 further includes D1 bits 108B for said second group of pixels that are DPCM or bXOR encoded per pixel (DIFF pixels).

The above hard truncation example is a simple solution to reduce the transmission bandwidth requirement. To avoid the introduction of error for DIFF pixels, if D1 bits are not sufficient for all of the bits of the DPCM or bXOR encoded value, then RLC is used for the DIFF pixels and the bit order is reorganized in each DIFF packet to carry DIFF pixels.

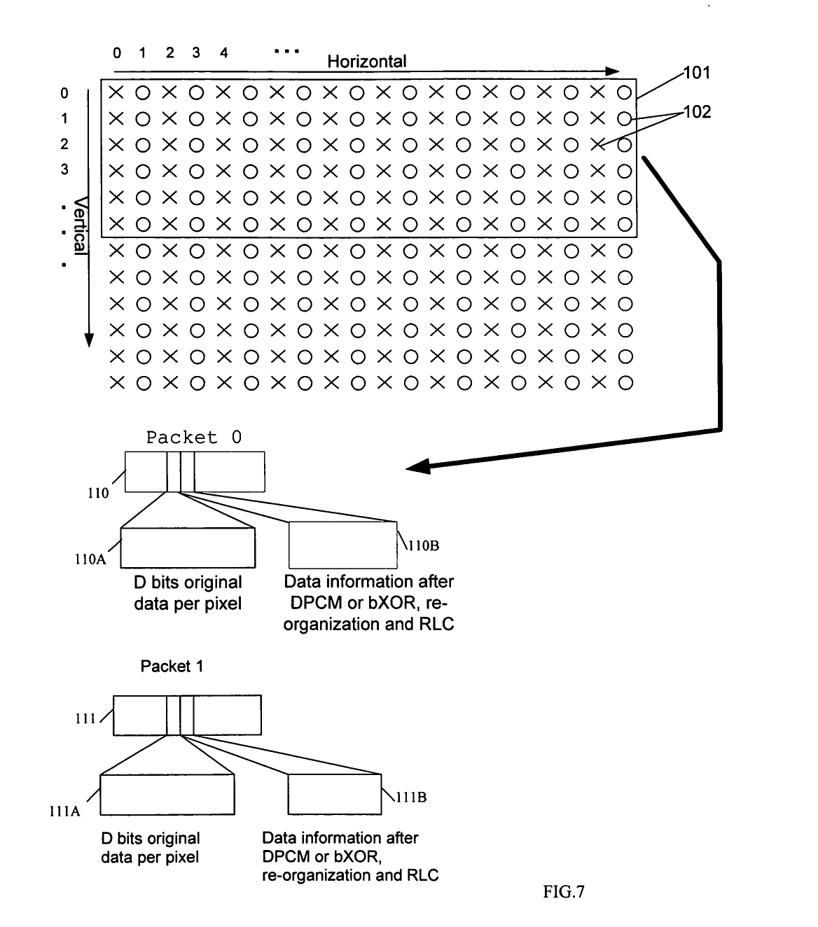

FIG. 7 shows an encoding scheme based on DPCM (or bXOR) and RLC for DIFF pixels to protect BASE pixels in an example wherein K=2 partitions. Similar to FIG. 6, in FIG. 7 the pixels are split horizontally into two groups: (1) the first group of pixels have the indices i=0, 2, 4, . . . , etc., and j=0, 1, 2, . . . , etc.; and (2) the second group of pixels have indices i=1, 3, 5, . . . , etc., and j=0, 1, 2, . . . , etc.

A first packet 110 (i.e., Packet 0) is constructed which includes D bits 110A of the original data per pixel from said first group of pixels (BASE pixels). The first packet 110 further includes data information 110B after DPCM or bXOR encoding, reorganization and RLC, per pixel from said first group of pixels (DIFF pixels).

Similarly, a second packet 111 (i.e., Packet 1) is constructed which includes D bits 111A of original data per pixel from said second group of pixels (BASE pixels). The second packet 111 further includes data information 111B after DPCM or bXOR encoding, reorganization and RLC, per pixel from said second group of pixels (DIFF pixels).

The bits of the DIFF pixels in a DIFF packet 112 are grouped and re-ordered according to their information significance in the pixel. For example, the first MSBs of all pixels are grouped together, which are followed by the second MSBs of all pixels, and so on, up to the LSBs (Least Significant Bits) of all pixels. Then, RLC is applied either to the reorganized DIFF bits stream or to just the MSBs part of the reorganized bit stream. Since after DPCM or bXOR encoding most MSBs are zero, RLC can achieve high compression ratio without loss of any information. Multiple DIFF packets can be aggregated together to reduce various MAC layer overhead in wireless transmission.

The above described encoding methods can be implemented in the transmitter 202 of system 200 in FIG. 5, as a logical component of the packetization module 212. The de-packetization and decoding module 217 in the receiver 204 then performs decoding steps which are inverse to the encoding steps in the transmitter 202.

As is known to those skilled in the art, the aforementioned example architectures described above, according to the present invention, can be implemented in many ways, such as program instructions for execution by a processor, as logic circuits, as an ASIC, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of transmitting uncompressed video over a wireless channel, comprising the steps of:
inputting a frame of uncompressed video pixel information;
partitioning spatially correlated pixels into different partitions, and placing pixels from different partitions into different packets;
generating error detection data for each packet, and appending the error detection data to each packet; and
transmitting each packet separately over the wireless channel.

2. The method of claim 1 further comprising the steps of:
receiving a transmitted packet;
based on the appended error detection data, checking if a received packet is corrupt;
recovering corrupt pixels using pixel information in other received packets containing spatially correlated pixels; and
reconstructing the video frame from the spatially correlated pixels in the packets.

3. The method of claim 1 wherein the step of recovering the corrupt pixels further includes the steps of:
determining a difference between each pixel in the corrupt packet with a corresponding pixel of an adjacent non-corrupt packet; and
if the difference is greater than a threshold, then recovering each corrupt pixel using corresponding pixel information in an adjacent non-corrupt packet.

4. The method of claim 3 wherein the step of recovering each corrupt pixel using pixel information in an adjacent non-corrupt packet further includes the steps of replacing each corrupt pixel with a corresponding pixel from an adjacent non-corrupt packet.

5. The method of claim 4 wherein the step of partitioning further includes the steps of partitioning the pixels, such that pixels with minimal spatial distance are placed into different packets for transmission over the wireless channel.

6. The method of claim 1 wherein the step of partitioning the pixels into different packets further includes the steps of:
partitioning spatially correlated pixels into K different partitions;
selecting the value of the n^{th} pixel at every K pixel block as base information, wherein n<K;
for each block:
placing the base information in a packet as BASE pixels; and
encoding information of other pixels in the block as DIFF pixels, and placing the DIFF pixels in another packet.

7. The method of claim 6 wherein the step of encoding further includes the steps of using DPCM encoding.

8. The method of claim 6 wherein the step of encoding further includes the steps of using bXOR encoding.

9. The method of claim 6 further comprising the steps of, after encoding, truncating MSBs with zero values before transmission of a packet.

10. The method of claim 9 further comprising the steps of truncating the high order zero bits of encoded DIFF pixels.

11. The method of claim 9 further comprising the steps of performing RLC for the DIFF pixels and re-ordering the bit order in each packet to carry DIFF pixels.

12. A method of transmitting uncompressed video over a wireless channel, comprising the steps of:
inputting a frame of uncompressed video pixel information;
partitioning spatially correlated pixels into K different partitions;
selecting the value of the n^{th} pixel at every K pixel block as base information, wherein n<K;
for each block:
placing the base information in a packet as BASE pixels; and
encoding information of other pixels in the block as DIFF pixels, and placing the DIFF pixels in another packet; and
transmitting each packet separately over a wireless channel.

13. The method of claim 12 wherein the step of encoding further includes the steps of using DPCM encoding.

14. The method of claim 12 wherein the step of encoding further includes the steps of using bXOR encoding.

15. The method of claim 12 further comprising the steps of, after encoding, truncating MSBs with zero values before transmission.

16. The method of claim 15 further comprising the steps of truncating the high order zero bits of encoded DIFF pixels.

17. The method of claim 15 further comprising the steps of performing RLC for the DIFF pixels and re-ordering the bit order in each packet to carry DIFF pixels.

18. The method of claim 12 wherein the step of partitioning includes the steps of partitioning the pixels such that pixels with minimal spatial distance are placed into different packets for transmission over the wireless channel.

19. The method of claim 12 wherein the step of partitioning comprises the steps of partitioning the pixels in the frame horizontally.

20. The method of claim 12 wherein the step of partitioning comprises the steps of partitioning the pixels in the frame vertically.

21. The method of claim 12 wherein the step of partitioning comprises the steps of partitioning the pixels in the frame horizontally and vertically.

22. The method of claim 12 wherein the step of partitioning comprises the steps of partitioning the pixels into two or more partitions.

23. The method of claim 12 further comprising the steps of:
receiving a transmitted packet;
decoding the encoded pixels per packet; and
reconstructing the video frame from the spatially correlated pixels in the packets.

24. A wireless communication system comprising:
a wireless transmitter including:
a partitioning module that is configured to input uncompressed video pixels from a video frame and partition neighboring pixels into different partitions;
a packetization module that is configured to place the pixels from different partitions into different packets for transmission over the wireless channel; and
a wireless receiver including:
an error recovery module that is configured to receive packets and check for corrupt packets, the error recovery module being further configured to recover a corrupt pixel in a corrupt packet using pixel information in other received packets that contain neighboring pixels.

25. The system of claim 24 wherein the error recovery module is further configured to: determine a difference between each pixel in a corrupt packet and a corresponding pixel in an adjacent non-corrupt packet, such that if the difference is greater than a threshold, the error recovery module corrects a corrupt pixel using pixel information in the adjacent non-corrupt packet.

26. The system of claim 25 wherein the error recovery module is further configured to correct each corrupt pixel based on an average value of neighboring pixels in the adjacent non-corrupt packet.

27. The system of claim 26 wherein the error recovery module is further configured to correct each corrupt pixel by replacing the corrupt pixel with a corresponding pixel in the adjacent non-corrupt packet.

28. The system of claim 27 wherein the partitioning module is further configured to partition the pixels such that pixels with minimal spatial distance are placed into different packets for transmission over the wireless channel.

29. The system of claim 24 wherein:
the partitioning module is further configured to partition the pixels into K different partitions;
the packetization module is further configured to select the value of the n^{th} pixel at every K pixel block as base information, and for each block, place the base information in a packet as BASE pixels; and
the transmitter further includes and encoder that is configured to encode information of other pixels in the block as DIFF pixels, and place the DIFF pixels in said packet.

30. The system of claim 29 wherein the encoder is further configured to perform encoding using DPCM encoding.

31. The system of claim 29 wherein the encoder is further configured to perform encoding by bXOR encoding.

32. The system of claim 29 wherein the encoder is further configured to eliminate MSBs with zero values before transmission.

33. The system of claim 32 wherein the encoder is further configured to truncate the high order zero bits of encoded DIFF pixels.

34. The system of claim 32 wherein the encoder if further configured to perform RLC for the DIFF pixels and re-orders the bit order in each packet to carry DIFF pixels.

35. The system of claim 24 wherein the receiver further includes a de-partitioning module that is configured to reconstruct the video frame from the partitioned pixels in each received packet.

36. The system of claim 29 wherein the receiver further includes a decoder that is configured to decode the encoded pixels in each received packet.

37. A wireless transmitter comprising:
a partitioning module that is configured to input uncompressed video pixels from a video frame and partition neighboring pixels into different partitions;
an error detection information generator that is configured to calculate error detection data for each packet and append the error detection data to the packet before transmission; and a packetization module that is configured to place the pixels from different partitions into different packets for transmission over a wireless channel.

38. The transmitter of claim 37 further comprising an error detection information generator that is configured to calculate error detection data for each packet and append the error detection data to the packet before transmission.

39. The transmitter of claim 38 wherein the partitioning module is further configured to partition the pixels such that pixels with minimal spatial distance are placed into different packets for transmission over the wireless channel.

40. The transmitter of claim 39 wherein:
the partitioning module is further configured to partition the pixels into K different partitions;
the packetization module is further configured to select the value of the n^{th} pixel at every K pixel block as base information, and for each block, place the base information in a packet as BASE pixels; and
the transmitter further includes and encoder that is configured to encode information of other pixels in the block as DIFF pixels, and place the DIFF pixels in said packet.

41. The transmitter of claim 40 wherein the encoder is further configured to perform encoding using DPCM encoding.

42. The transmitter of claim 40 wherein the encoder is further configured to perform encoding by bXOR encoding.

43. The transmitter of claim 40 wherein the encoder is further configured to eliminate MSBs with zero values before transmission.

44. The transmitter of claim 40 wherein the encoder is further configured to truncate the high order zero bits of encoded DIFF pixels.

45. The transmitter of claim 40 wherein the encoder is further configured to perform RLC for the DIFF pixels and re-orders the bit order in each packet to carry DIFF pixels.

46. A wireless receiver comprising:
an error detection module that is configured to receive packets of video pixel information and check for corrupt packets; and
an error recovery module that is configured to recover a corrupt pixel in a corrupt packet using corresponding pixel information in other received packets that contain spatially correlated pixels.

47. The receiver of claim 46 wherein different packets include different spatially correlated pixels of an uncompressed video frame.

48. The receiver of claim 47 wherein the packets include video pixels that form partitions of spatially correlated pixels in the video frame.

49. The receiver of claim 48 further comprising a de-partitioning module that is configured to reconstruct the video frame partitions from the partitioned pixels in a plurality of received packets.

50. The receiver of claim 46 wherein:
at least a portion of the pixels in each packet are encoded; and
the receiver further includes a decoder that decodes encoded pixels in each received packet.

51. The receiver of claim 46 wherein the error recovery module is further configured to: determine a difference between each pixel in a corrupt packet and a corresponding pixel in an adjacent non-corrupt packet, such that if the difference is greater than a threshold, the error recovery module corrects a corrupt pixel using pixel information in the adjacent non-corrupt packet.

52. The receiver of claim 51 wherein the error recovery module is further configured to correct each corrupt pixel by replacing the corrupt pixel with a corresponding pixel in the adjacent non-corrupt packet.

53. A method of receiving uncompressed video over a wireless channel, comprising the steps of:
receiving packets of video pixel information, wherein different packets include different spatially correlated pixels of an uncompressed video frame;
decoding encoded pixels in the received packets;;
checking for corrupt packets; and
recovering a corrupt pixel in a corrupt packet using corresponding pixel information in other received packets that contain spatially correlated pixels.

54. The method of claim 53 wherein different packets include different spatially correlated pixels of an uncompressed video frame.

55. The method of claim 54 wherein the packets include video pixels that form partitions of spatially correlated pixels in the video frame.

56. The method of claim 55 further comprising: reconstructing the video frame partitions from the partitioned pixels in a plurality of received packets.

57. The method of claim 53 wherein:
at least a portion of the pixels in each packet are encoded; and
the method further includes the step of decoding encoded pixels in each received packet.

58. The method of claim 53 wherein the step of recovering a corrupt pixel further comprises the steps of:
determining a difference between each pixel in a corrupt packet and a corresponding pixel in an adjacent non-corrupt packet; and
if the difference is greater than a threshold value, then correcting a corrupt pixel using pixel information in the adjacent non-corrupt packet.

59. The method of claim 58 wherein the step of correcting a corrupt pixel further comprises the steps of correcting each corrupt pixel by replacing the corrupt pixel with a corresponding pixel in the adjacent non-corrupt packet.
